(19) United States
(12) Patent Application Publication
(10) Pub. No.: US 2026/0226759 A1
(43) Pub. Date: Aug. 6, 2026

(54) COMBINATION STEP BOLT AND FALL PROTECTION ANCHORAGE ASSEMBLIES

(71) Applicant: Crown Castle USA Inc., Canonsburg, PA (US)

(72) Inventors: Matt BRANAGAN, Canonsburg, PA (US); James RUEDLINGER, Evansville, IN (US); Kerry JOHNSON, Glide, OR (US); Christian BEAUCHAMP, Mountain Home, ID (US)

(21) Appl. No.: 19/434,974

(22) Filed: Dec. 29, 2025

Related U.S. Application Data
(63) Continuation of application No. 17/021,609, filed on Sep. 15, 2020, now Pat. No. 12,509,895.
Application No. 17/021,609 is a continuation of application No. 15/727,017, filed on Oct. 6, 2017, now Pat. No. 10,781,598.
(60) Provisional application No. 62/404,949, filed on Oct. 6, 2016.

(51) Int. Cl. E04G 21/32; A62B 35/00; E04C 3/30; E04H 12/00; E06C 7/18; E06C 9/04

(52) U.S. Cl. CPC E04G 21/3276; A62B 35/0068; E04H 12/00; E06C 7/18; E06C 9/04; E04C 3/30

(57) ABSTRACT

Combination step bolt and fall protection anchorage assemblies are disclosed that may be mounted on structures such as communication towers, poles and antennas. The assemblies include a mounting plate that can be bolted to the structure, an integrated anchorage clip connected to the mounting plate having at least one safety hook hole extending therethrough, and a step bolt secured to the integrated anchorage clip.

### CROSS-REFERENCE TO RELATED APPLICATION

This application is a continuation of U.S. application Ser. No. 17/021,609, filed Sep. 15, 2020, which is a continuation of U.S. application Ser. No. 15/727,017, filed 6 Oct. 2017, now U.S. Pat. No. 10,781,598, which claims priority from U.S. Provisional Application No. 62/404,949 filed Oct. 6, 2016, which are both incorporated herein by reference.

### FIELD OF THE INVENTION

The present invention relates to combination step bolt and fall protection anchorage assemblies for use on structures, such as communication towers, poles and antennas.

### BACKGROUND INFORMATION

Step bolts are typically mounted on structures that contain communication or electrical transmission equipment to be used as steps. Conventional structures that contain communication or electrical transmission equipment are constructed to have clips welded thereon for engaging step bolts along their heights. Step bolts are typically mounted on such structures in holes, e.g., by installing a threaded step bolt directly into a hole in a welded clip and securing it with two nuts, one on each side of the clip.

### SUMMARY OF THE INVENTION

The present invention provides combination step bolt and fall protection anchorage assemblies that may be mounted on structures such as communication towers, poles and antennas. The assemblies include a mounting plate that can be bolted to the structure, an integrated anchorage clip connected to the mounting plate having at least one safety hook hole extending therethrough, and a step bolt secured to the integrated anchorage clip.

An aspect of the present invention provides a combination step bolt and fall protection anchorage assembly for mounting on structures. The assembly comprises a mounting plate, an integrated anchorage clip secured to the mounting plate comprising at least one safety hook hole extending therethrough, and a step bolt secured to the integrated anchorage clip and extending away from the mounting plate in a direction substantially perpendicular to a plane defined by the mounting plate.

Another aspect of the present invention provides a structure comprising multiple combination step bolt and fall protection anchorage assembles mounted thereon. Each assembly comprises a mounting plate, an integrated anchorage clip secured to the mounting plate comprising at least one safety hook hole extending therethrough, and a step bolt secured to the integrated anchorage clip and extending away from the mounting plate in a direction substantially perpendicular to a plane defined by the mounting plate.

These and other aspects of the present invention will be more apparent from the following description.

### BRIEF DESCRIPTION OF THE DRAWINGS

FIG. 1 is a profile or side view of a support structure in the form of a monopole communication tower including combination step bolt and fall protection anchorage assemblies in accordance with an embodiment of the present invention.

FIG. 2 is a magnified view of a portion of the support structure shown in FIG. 1.

FIG. 3 is a side view of a portion of a support structure including multiple combination step bolt and fall protection anchorage assemblies in accordance with an embodiment of the present invention.

FIG. 4 is a side view of a combination step bolt and fall protection anchorage assembly secured to a support structure in accordance with an embodiment of the present invention.

FIG. 5 is a side view of a mounting plate and integrated anchorage clip of a combination step bolt and fall protection anchorage assembly in accordance with an embodiment of the present invention.

FIG. 6 is a top view of the mounting plate and integrated anchorage clip of FIG. 5.

FIG. 7 is a side view of the integrated anchorage clip of FIG. 5.

FIG. 8 is a front view of the integrated anchorage clip of FIG. 5.

FIG. 9 illustrates a safety hook that may be used with a combined step bolt and fall protection anchor assembly in accordance with an embodiment of the present invention.

FIG. 10 is an isometric view of a combined step bolt and fall protection anchor assembly having a safety hook mounted thereon in accordance with an embodiment of the present invention.

### DETAILED DESCRIPTION

The present invention provides combination step bolt and fall protection anchorage assemblies for structures that contain communication or electrical transmission equipment. As used herein, the term “structure” may refer to cellular towers, communication towers, monopoles, utility poles, lattice structures, antennas, or any vertical structure. The structure may be of any known design and may typically be made of metal, wood, concrete, composites, or the like.

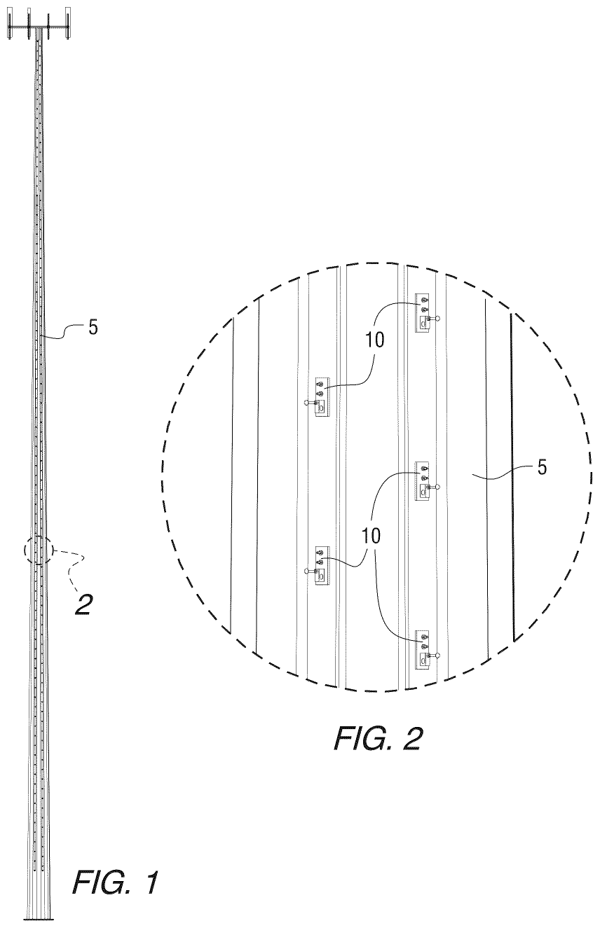

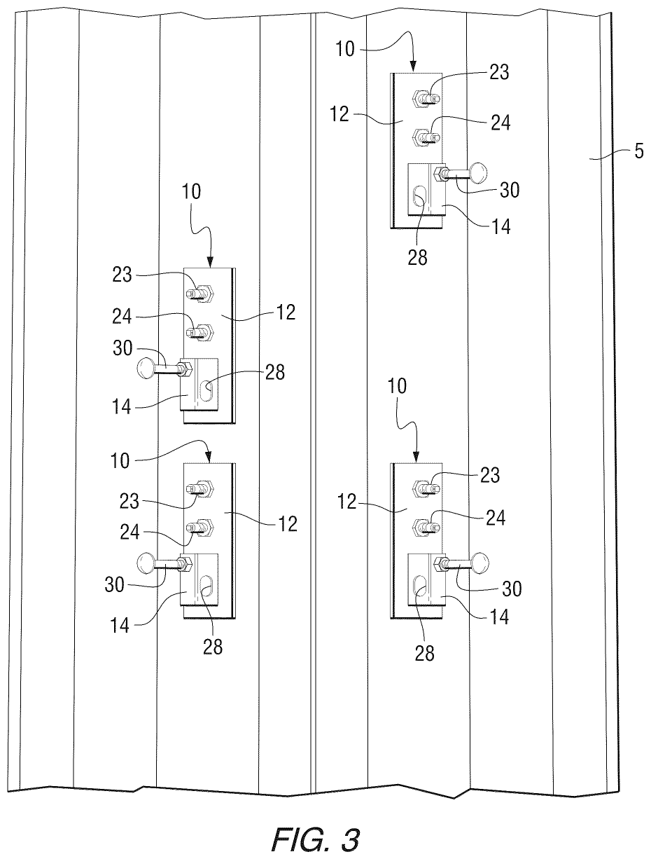

FIG. 1 illustrates a support structure 5 in the form of a monopole communication tower upon which combination step bolt and fall protection anchorage assemblies 10 may be installed in accordance with an embodiment of the present invention. The assemblies 10 can be used for new structure construction or to retrofit existing structures. FIG. 2 is a magnified portion of the support structure 5 of FIG. 1, illustrating multiple combination step bolt and fall protection anchorage assemblies 10 installed thereon. FIG. 3 is a further magnified view showing multiple assemblies 10 installed on the support structure 5. The series of combination step bolt and fall protection anchorage assemblies 10 may be mounted to the structure 5 to provide a means for climbing the structure 5. The combination step bolt and fall protection anchorage assemblies 10 near the technician may also serve as fall protection anchorage for the safety hook of the technician's climbing lanyard(s) for maintaining complete tie-off through use of the fall protection anchorages alone, as a secondary backup to the primary fall protection system, or as an alternative fall protection anchorage to facilitate working at locations away from the primary fall protection system. The combination step bolt and fall protection anchorage assemblies 10 provide for easily installable fall protection devices at desired locations. The assemblies 10 may be spaced vertically above each other any suitable distance, for example, up to 48 inches, or from 6 to 42 inches, or from 12 to 40 inches.

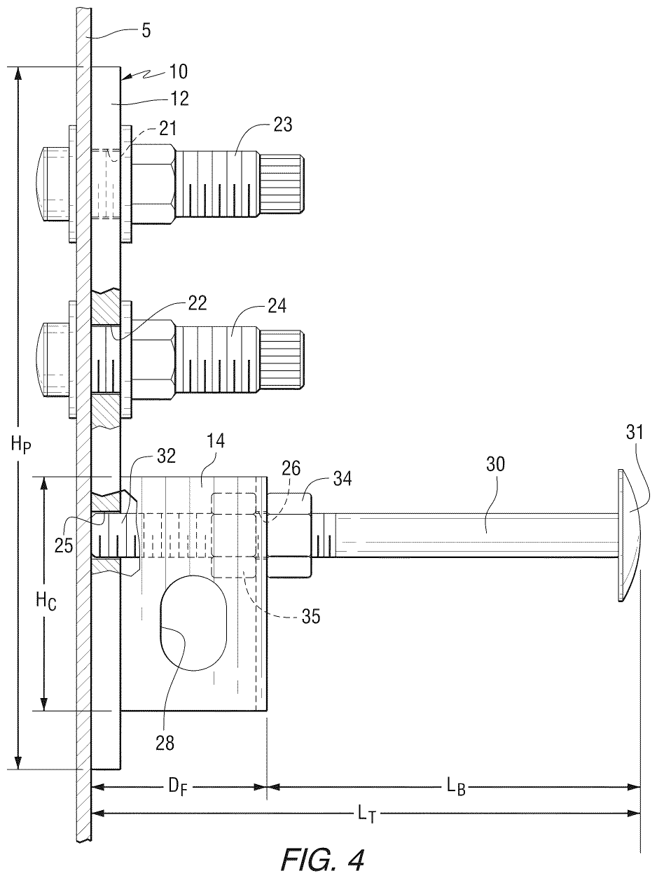

FIGS. 4-8 and 10 illustrate details of a combination step bolt and fall protection anchorage assembly 10 in accordance with an embodiment of the present invention. The assembly 10 includes a mounting plate 12 having an integrated anchorage clip 14 mounted thereon. The integrated anchorage clip 14 includes a first side panel 15, a second side panel 16, and a face plate 18. In the embodiment shown, the first and second side panels 15 and 16, and the face plate 18, form a channel having a generally U-shaped cross section. The integrated anchorage clip 14 may be secured to the mounting plate 12 by any suitable means, for example, by welds 19 as shown in FIG. 6. However, any other suitable type of attachment may be used, e.g., with mechanical fasteners, a slot connection or the like. In certain embodiments, the integrated anchorage clip 14 and the mounting plate 12 may be integrally formed.

As shown in FIG. 4, the mounting plate 12 has a height Hp, and the integrated anchorage clip 14 has a height H_{C}. The mounting plate height Hp may typically range from 6 to 24 inches, for example, from 8 to 18 inches, or from 10 to 12 inches. The integrated anchorage clip height H_{C} may typically range from 2 to 8 inches, for example, from 2 to 4 inches. The thickness of the mounting plate 12 may typically range from 0.25 to 1.25 inches, for example, from 0.375 to 1 inch, or about 0.75 inch. The thickness of the integrated anchorage clip 14 may typically range from 0.125 to 1.25 inches, for example, from 0.125 to 0.375 inch, or about 0.1875 inch.

An upper hole 21 is provided through the mounting plate 12, and a lower hole 22 is provided through the mounting plate 12. An upper fastener mounting bolt 23 is provided through the upper hole 21 and a lower fastener bolt 24 is provided through the lower hole 22.

The upper and lower fastener bolts 23 and 24 may be provided in the form of conventional blind bolts in the embodiment shown in FIG. 4. However, it is to be understood that any other suitable type of bolt or mechanical fastener may be used. Furthermore, any other suitable number of fastener bolts may be used, including a single fastener, or three or more fasteners. Although the mounting plate 12 may alternatively be welded to the support structure 5 without the use of mechanical fasteners, the use of mechanical fasteners provides advantages of less risk from fire due to welding, less damage to protective coatings of the structures such as galvanization, and increased efficiently of installation and inspection.

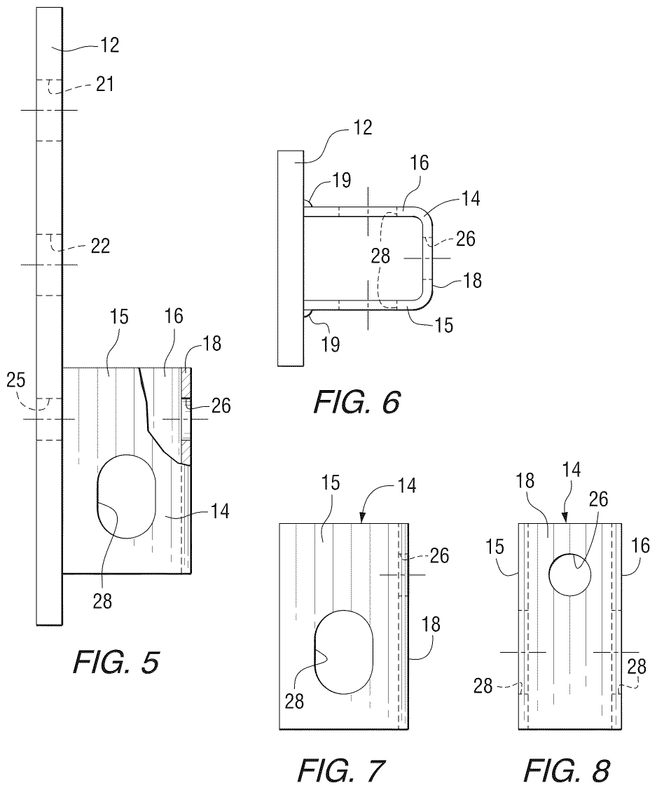

As shown in FIGS. 4 and 5, a step bolt hole 25 is provided through the mounting plate 12. As more fully described below, the step bolt hole 25 may be unthreaded and receives the threaded end of a step bolt. As shown in FIGS. 4-8, the integrated anchorage clip 14 includes an unthreaded step bolt hole 26 through the face plate 18. Alternatively, the step bolt hole 26 in the front face 18 of the U-shaped integrated anchorage clip 14 may be threaded to engage the threaded portion of the step bolt 30 or the mounting plate 12 may be threaded to serve as the step bolt 30 attachment point.

Safety hook holes 28 are provided through the side panels 15 and 16 for receiving a safety hook, as more fully described below. In the embodiment shown, the safety hook holes 28 are vertically elongated. However, any other suitable hole shape may be used.

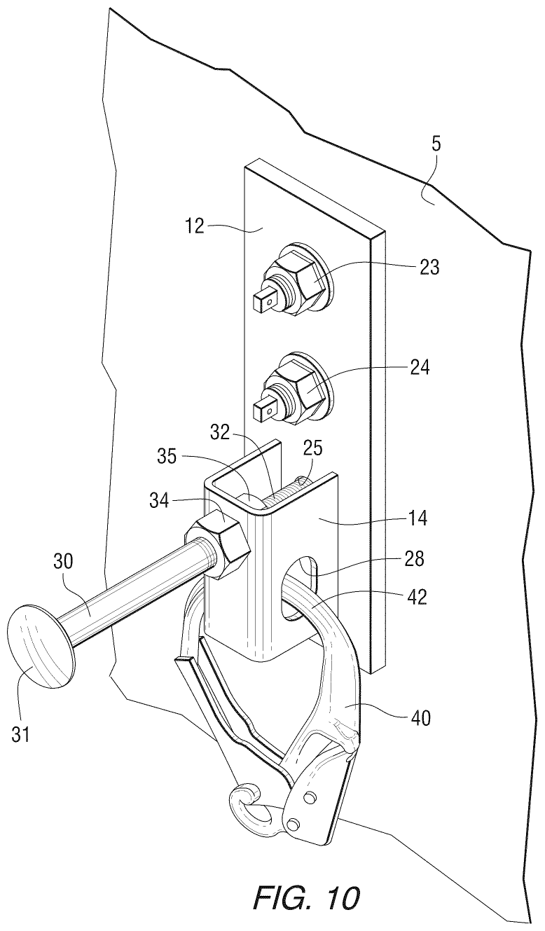

As shown in FIGS. 4 and 10, the assembly 10 includes a step bolt 30 having a head 31 at one end and an opposite threaded end 32. The step bolt 30 passes through the step bolt hole 26 of the face plate 18, and also extends into the step bolt hole 25 of the mounting plate 12. An exterior threaded nut 34 is threaded onto the step bolt 30 against the exterior surface of the face plate 18. An interior threaded nut 35 is threaded on the step bolt 30 against an interior face of the face plate 18.

In the embodiment shown, the safety hook holes 28 extend through the first and second side walls 15 and 16 of the integrated anchorage clip 14 at a height that is vertically below the height of the step bolt hole 26 extending through the face plate 18. This arrangement provides safety hook holes 28 below the step bolt 30 of each assembly 10.

As shown in FIG. 4, the face plate 18 of the integrated anchorage clip 14 extends a distance D_{F} from the rear surface of the mounting plate 12. The extended distance D_{F} may typically range from 1 to 5 inches, for example, from 2 to 4 inches. The step bolt 30 has an exposed length L_{B} measured from the exterior surface of the face plate 18 to the end of the head 31. The step bolt 30 also has a total length L_{T} measured from the exterior surface of the support structure 5 to the end of the head 31. The exposed length L_{B} may typically range from 4 to 9 inches, for example, from 5 to 8 inches. The integrated anchorage clip 14 has a depth sufficient to accommodate the threaded portion of the step bolt 30 and the interior threaded nut 35. In the embodiment shown, the step bolt 30 is threadingly engaged with interior and exterior nuts 35 and 34; however, any other suitable type of arrangement may be used, e.g., clips, pins, adhesive or the like.

The extended distance D_{F} of the face plate 18 provides several advantages over conventional step bolt designs. For example, the extended distance D_{F} of the face plate 18 provides an offset from the external surface of the support structure 5 that extends the foot-engaging and/or hand-engaging portion of the step bolt 30 horizontally beyond the upper and lower fastener bolts 23 and 24. In this manner, the area above the step bolt 30 is not obstructed by the upper and lower fastener bolts 23 and 24, thereby facilitating placement of a worker's foot or hand on the step bolt without unwanted contact with the fastener bolts.

The components of the combination step bolt and fall protection anchorage assembly 10 of the present invention may be made from any suitable materials known to those skilled in the art. For example, the anchor plate 12 and integrated anchorage clip 14 may be made from steel, aluminum, composite polymer material or the like.

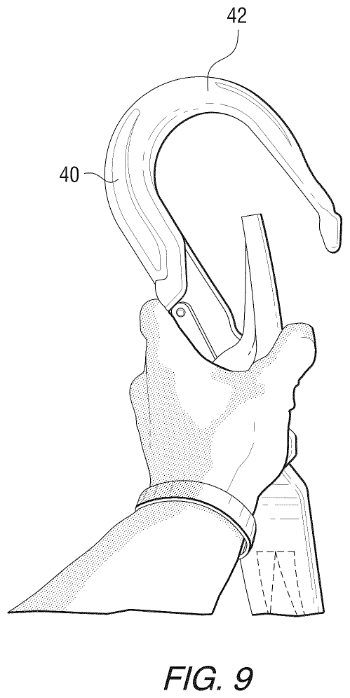

FIGS. 9 and 10 illustrate a safety hook 40 that may be used with the assembly 10 in accordance with an embodiment of the present invention. As shown in FIG. 10, an engagement portion 42 of the safety hook 40 may be installed through the hook holes 28 of the first and second side panels 15 and 16. The U-shaped integrated anchorage clip 14 may comprise a single or multiple fall protection anchorage holes 28 for receiving the climbing lanyard safety hook 40 as a fall protection anchorage point. The available mounting options made possible by the combination step bolt and fall protection anchorage assembly 10 allows the assembly to be bolted directly to the structure in lieu of welding. As understood by those skilled in the art, the safety hook 40 is secured to conventional safety strap and harness equipment (not shown) to provide increased safety for workers servicing the support structure 5.

The side anchorage holes 28 thus serve as a fall protection anchorage for attaching the climbing lanyard safety hook 40. The integrated anchorage clip 14 may be symmetrical around the step bolt hole in the front face, which provides a technician easy access to the side anchorage holes 28 regardless of which side of the combination step bolt and fall protection anchorage assembly 10 they approach. This arrangement consistently provides the technician with access to the side anchorage holes 28 without having to reach under and/or work around the step bolt 30. The safety hook may engage both legs of the U-shaped step bolt clip 14 to provide two points of support and distribute the weight of the technician across the combination step bolt and fall protection anchorage, thus ensuring that the assembly 10 can support the technician. The vertical distance between the step bolt hole 26 on the front face 18 and the side anchorage holes 28 may also allow the safety hook 40 to be easily inserted into the combination step bolt and fall protection anchorage assembly 10 without interference from the step bolt 30.

Thus, in accordance with the present invention, the integrated anchorage clip 14 secures the step bolt 30 at one location and provides an integrated fall protection anchorage point for the safety lanyard hook 40 at another point. The integrated anchorage clip 14 may also provide a more substantial engagement between the step bolt 30 and the mounting plate 12. The two legs of the integrated anchorage clip 14 provide at least two points of engagement with the plate 12.

An advantage of the present invention is that the integrated side fall protection anchorage holes 28 may be provided below the step bolt 30 to provide unobstructed access to the step bolt and fall protection anchorage. However, the side fall protection anchorage holes can be placed in other locations relative to any bolt. This arrangement provides for convenient access to fall protection anchorage points when the technician is climbing. In accordance with an embodiment of the present invention, when the technician is reaching for a grip/handhold on the step bolt above the technician, the side anchorage holes being located under the step bolt allows the technician to easily insert the safety hook into the combination step bolt and fall protection anchorage before grabbing the step bolt.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step.

As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. An assembly comprising:
a plate configured to be mounted to a structure, wherein the plate has a first bolt hole; and
an anchorage affixed to the plate, the anchorage comprising a first side panel, a second side panel, and a face plate, wherein the first side panel and the second side panel extend from the plate, the face plate extends between the first side panel and the second side panel, at least one of the first side panel and the second side panel has a safety hook hole, and the face plate has a second bolt hole,
wherein the first bolt hole and the second bolt hole are configured to receive a step bolt, and the at least one safety hook hole is configured to receive a safety hook.

2. The assembly of claim 1, wherein each of the first side panel and the second side panel has a safety hook hole.

3. The assembly of claim 1, wherein the at least one safety hook hole is vertically elongated.

4. The assembly of claim 1, wherein the at least one safety hook hole is located at a first vertical height, the first bolt hole and the second bolt hole are located at a second vertical height, and the second vertical height is above the first vertical height.

5. The assembly of claim 1, wherein the anchorage forms a U-shaped channel.

6. The assembly of claim 1, wherein the plate and the anchorage are integrally formed.

7. The assembly of claim 1, further comprising a step bolt received in the first bolt hole and the second bolt hole.

8. The assembly of claim 7, wherein the step bolt is received in the first bolt hole and extends through the second bolt hole and away from the face plate.

9. The assembly of claim 7, wherein the step bolt extends a length of 4 to 9 inches away from the face plate.

10. The assembly of claim 7, further comprising:
a first nut threaded on the step bolt; and
a second nut threaded on step bolt,
wherein the face plate is positioned between the first nut and the second nut.

11. The assembly of claim 1, further comprising a fastener bolt configured to secure the plate to the structure.

12. An assembly comprising:
a plate configured to be mounted to a structure, wherein the plate has a first bolt hole;
an anchorage affixed to the plate, the anchorage comprising a first side panel, a second side panel, and a face plate, wherein the first side panel and the second side panel extend from the plate, the face plate extends between the first side panel and the second side panel, at least one of the first side panel and the second side panel has a safety hook hole, and the face plate has a second bolt hole; and
a step bolt received in the first bolt hole and the second bolt hole,
wherein the at least one safety hook hole is configured to receive a safety hook.
